(19) United States
(12) Patent Application Publication
(10) Pub. No.: US 2005/0283992 A1
(43) Pub. Date: Dec. 29, 2005

(54) Process for producing garden furniture from locust wood

(76) Inventor: Heinz Kettler, Ense (DE)

Correspondence Address: HOFFMAN, WASSON & GITLER, P.C.;Crystal Center 2, Suite 522, 2461 South Clark Street, Arlington, VA, 22202, US

(21) Appl. No.: 10/954,344

(22) Filed: Oct. 1, 2004

(30) Foreign Application Priority Data
Oct. 1, 2003 (DE) 103 45 900.6
Oct. 24, 2003 (DE) 103 49 799.4

(51) Int. Cl. F26B 7/00

(52) U.S. Cl. 34/396

(57) ABSTRACT

This invention relates to a process for producing garden furniture from locust wood, including a one process step in which the locust wood is treated, the locust wood being steamed such that a color change of the locust wood from a yellowish to the brownish shade takes place.

### BACKGROUND OF THE INVENTION

This invention relates to a process for producing garden furniture from locust wood, including a one process step in which the locust wood is treated.

Processes of the aforementioned type have been known for a long time. Locust wood is outstandingly well suited for the production of garden furniture, because it is harder, more weather resistant and more durable than most other woods. In particular, locust wood with respect to its hardness, weather resistance and durability is even superior to teak wood, which has long been preferred for the outdoors. Furthermore, compared to teak wood, locust wood has the advantage that locust wood is not a tropical wood, but a wood which can be cultivated in Europe. The use of locust wood for garden furniture thus does not contribute to deforestation of the rain forest.

It is commonly regarded as the disadvantage of locust wood, that locust wood, in the natural state, has a comparatively unattractive yellowish tint. This yellowish tint of locust wood is accompanied by a comparatively high concentration of tannic acid in locust wood. The existing processes for producing garden furniture from locust wood call for the locust wood to be treated by applying clear varnishes or colored lacquers. Applying clear varnishes yields garden furniture with the unattractive yellow tint, which is inherent in locust wood. Applying colored lacquers generally yields garden furniture with a surface, which has an unattractive surface composition with respect to touching. This is due, among others, to the fact that as a result of the high tannic acid concentration within the locust wood, a lacquer which is not open-pored must be used to prevent diffusion of the tannic acid to the outside.

An object of this invention is to devise a process of the initially mentioned type with which an attractive surface of the locust wood can be produced.

### SUMMARY OF THE INVENTION

This is achieved in that the locust wood is steamed such that a color change of the locust wood from a yellowish to the brownish shade takes place. Steaming of wood has been used according to the existing art for impregnation of wood. It was unexpectedly found that in locust wood, steaming can cause a change in color from yellowish to brownish. Furthermore, under certain circumstances, steaming can also reduce the tannic acid concentration. In particular, by the aforementioned color change, garden furniture with an attractive surface can be built.

It is provided that locust wood is steamed for at least 30, and preferably at least 60 hours.

It is further provided that locust wood is steamed between 60 and 90 hours, especially roughly 80 hours. It has been found that depending on the thickness of the wood which is to be steamed, after an average of 80 hours, the desired color change has taken place both on the surface and also within the wood.

The locust wood can be steamed at a temperature between 90° and 110° C., especially at a temperature between 95° and 105° C. At very low temperatures, steaming would accordingly have to continue for a longer time.

It can be provided that locust wood is steamed at a humidity of 100%.

It can be provided that locust wood is steamed at latest 4 weeks after being cut down, especially at latest two weeks after cutting. It has been shown that the color change, which can be achieved by steaming can no longer be achieved under certain circumstance when the waiting too long of a time until steaming of the locust wood is begun too long after cutting.

It can be provided that before steaming, boards are cut from the felled trunks; the boards in particular have a thickness between 23 mm and 45 mm. Depending on the thickness of these boards, steaming must be correspondingly shorter or longer.

It can be provided that the locust wood is dried after steaming.

It can be provided that the locust wood is dried up to a wood moisture content from 9% to 12%, preferably up to a wood moisture content between 10% and 11%. This wood moisture content is comparatively ideal for further treatment of the wood.

It can be provided that drying is carried out roughly in a time interval between 10 and 25 days, especially in an interval between 15 to 20 days.

It can be provided that locust wood after steaming and before drying is stored for certain time interval. During storage the wood can be cured, by which crack formation in the wood is avoided.

It can be provided that locust wood after drying is mechanically worked, especially by cutting, milling, drilling, sanding or combinations thereof.

It can be provided that the locust wood after steaming, especially after mechanical working which takes place on drying, is surface-finished. This surface finishing can be achieved for example by a glaze. For example it can be a brown glaze. Alternatively, surface finishing can also be achieved by lacquering, especially by white lacquering.

It can be provided that surface finishing encompasses placement in a fungicide solution. This placement in a fungicide solution can take place especially before the joining of the individual parts of the garden furniture so that the joining sites are effectively protected.

It can be provided that surface finishing encompasses placement in a wood preservative solution. Placement in a wood preservative solution can be done for example by immersion.

It can be provided that priming is carried out, especially by immersion in a corresponding priming solution.

It can be provided that after carrying out the priming a coating lacquer is applied to the primer, especially by spraying.

It can be provided that the covering lacquer comprises paint pigments, especially brown paint pigments. The fungicide solution, the wood preservative solution, the primer and the covering lacquer yield a glaze which is comparatively resistant.

It can be provided that after application of the primer at least one intermediate coating is applied, especially by spraying. For example, two intermediate coatings can be applied, and between these two intermediate coatings drying can take place.

It can be provided that after application of an intermediate coating a coating lacquer is applied, especially by spraying.

It can be provided that the coating lacquer is white. By the fungicide solution, the primer, at least one intermediate coating and the coating lacquer thus lacquering, especially white lacquering, can be applied. The lacquering can be made open-porous, because the tannic acid can for the most part be removed by steaming. An open-pore lacquer offers a much more pleasing working surface to the user.

After surface finishing is completed, the corresponding garden furniture can be completely assembled.

Two specific embodiments of this invention are detailed below.

### EXAMPLE 1

The locust is cut down in the months from September to May. The locust trunks are cut into boards after they are cut down.

At the latest, two to four weeks after being cut down, the boards which have been cut to size, are steamed. The steaming takes place at a temperature between 95° and 105° C. at 100% humidity. Depending on the thickness of the cut boards, steaming can be longer or shorter. At average board thicknesses, from 23 mm to 45 mm, a reasonable steaming interval is between 60 hours and 90 hours, the average duration of the steaming process being roughly 80 hours.

The steamed boards are temporarily stored before they are dried in corresponding drying chambers to roughly 10% to 11% wood moisture content. This requires an average drying time from roughly 15 to 20 days. In particular, the wood is dried at a temperature of roughly 40° C. until the fiber saturation point is reached at roughly 25% wood moisture content. Subsequently, drying is continued at a temperature of roughly 55° C.

After drying, the boards are cut into pieces with a square or rectangular cross section which can be used for legs, armrests, and the like of garden furniture. Subsequently, the square or rectangular pieces are mechanically worked by milling and/or drilling and/or sanding and the like.

Subsequently, the surface finishing process is begun. In particular, the parts which have not yet been joined to one another are immersed in a fungicide solution in order to protect the later joining sites of individual parts of the garden furniture against fungal attack. After removal from the fungicide solution the parts are dried for at least 12 hours.

Then, the parts are at least partially joined to one another.

Subsequently, the parts which have been partially joined to one another are immersed in a wood preservative solution. The parts are then dried for at least 12 hours and sanded. Then the parts are immersed in a primer, dried for 12 hours after removal from the primer, and sanded. Then the parts are sprayed with a covering lacquer. The covering lacquer can especially have paint pigments, especially brown paint pigments. For example, the covering lacquer can have 10% brown paint pigments.

After the aforementioned surface finishing, the garden furniture is assembled into its final state. In particular fittings of V2A steel can be used so that the wood is not attacked by the fittings.

### EXAMPLE 2

In the second sample process, until after immersion in a fungicide solution and partial joining to one another, the process is the same as described under example 1.

To produce white lacquering the parts which have been partially joined to one another are immersed in a primer, dried for 12 hours and sanded. Then the parts are sprayed with an intermediate coating, dried for 12 hours and sanded. Then the parts are sprayed a second time with an intermediate coating, dried for 12 hours and sanded. Then a coating lacquer, especially a white coating lacquer, can be sprayed onto the parts which have been treated in this way.

The parts which have been lacquered white can be assembled into the final state analogously to Example 1.

1. A process for producing garden furniture from locust wood, comprising one process step in which the locust wood is treated, the locust wood is steamed such that a color change of the locust wood from a yellowish to a brownish shade takes place.

2. The process claimed in claim 1, wherein the locust wood is steamed for at least 30, hours.

3. (cancel) Process as claimed in claim 2, wherein the locust wood is steamed between 60 and 90 hours, especially roughly 80 hours.

4. The process as claimed in claim 1, wherein the locust wood is steamed at a temperature between 90° and 110° C.

5. The process as claimed in claim 1, wherein the locust wood is steamed at a humidity of 100%.

6. The process as claimed in claim 1, wherein the locust wood is steamed at latest 4 weeks after being cut down.

7. The process as claimed in claim 1, wherein before steaming, boards are cut from felled trunks and having a thickness between 23 mm and 45 mm.

8. The process as claimed in claim 1, wherein the locust wood is dried after steaming.

9. The process as claimed in claim 8, wherein the locust wood is dried up to a wood moisture content from 9% to 12%.

10. The process Process as claimed in claim 8, wherein drying is carried out roughly in a time interval between 10 and 25 days.

11. The process as claimed in claim 8, wherein the locust wood after steaming and before drying is stored for certain time interval.

12. The process as claimed in claim 8, wherein the locust wood after drying is mechanically worked, by cuttings milling, drilling, sanding, or combinations thereof.

13. The process as claimed in claim 1, wherein the locust wood after steaming, is surface-finished.

14. The process as claimed in claim 13, wherein the surface finishing encompasses placement in a fungicide solution.

15. (cancel) Process as claimed in one of claims 13 or 14, wherein surface finishing encompasses placement in a wood preservative solution.

16. The process as claimed in claim 15, wherein priming is carried out, by immersion in a corresponding priming solution.

17. The process as claimed in claim 16, wherein after carrying out the priming a covering lacquer is applied to the primer.

18. The process as claimed in claim 17, wherein the covering lacquer comprises paint pigments.

19. The process as claimed in claim 16, wherein after application of the primer at least one intermediate coating is applied.

20. The process as claimed in claim 19, wherein after application of an intermediate coatings a coating lacquer is applied.

21. The process as claimed in claim 20, wherein the coating lacquer is white.

22. The process as claimed in claim 13, wherein after surface finishing the corresponding garden furniture is completely assembled.
